(19) United States
(12) Patent Application Publication
(10) Pub. No.: US 2009/0272365 A1
(43) Pub. Date: Nov. 5, 2009

(54) Cam lobe profile for driving a mechanical fuel pump

(76) Inventor: Timothy W. Kunz, Rochester, NY (US)

Correspondence Address: DELPHI TECHNOLOGIES, INC., M/C 480-410-202, PO BOX 5052, TROY, MI, 48007, US

(21) Appl. No.: 12/150,687

(22) Filed: Apr. 30, 2008

(51) Int. Cl. F02M 37/06

(52) U.S. Cl. 123/508; 123/90.6

(57) ABSTRACT

In a fuel-pumping system in an internal combustion engine, a mechanical fuel pump roller actuator is slidably disposed to ride on a dedicated tri-lobate camshaft lobe. In prior art camshaft lobes for this purpose, a portion of the lift profile over a certain angle of camshaft rotation imparts a constant velocity, and hence zero acceleration and zero jerk, to the roller actuator. It has been found that such areas of zero acceleration give rise to undesirably high contact stress between the lobe and the roller actuator. In a method in accordance with the present invention, a reference radius of curvature of a reference camshaft lobe lift profile is adjusted such that, between regions of minimum lift and maximum lift, there are no regions imparting zero acceleration to the actuator and maximum contact stress is reduced.

### TECHNICAL FIELD

The present invention relates to a system for transferring the rotational motion of an eccentric camshaft lobe to the reciprocating motion of a high pressure mechanical fuel pump used in an internal combustion engine; more particularly, to the profile of the camshaft lobe; and most particularly to an improved camshaft lobe profile wherein the lobe radius of curvature is increased in portions of the lift profile having high pumping loads and maximum contact stress between the cam lobe and the lobe follower.

### BACKGROUND OF THE INVENTION

Fuel injected gasoline engines have become commonplace in the automotive industry. Fuel injection of the most current technology has evolved into two primary categories—multi-port fuel injection (MPFI), wherein fuel is injected into the runners of an air intake manifold ahead of the cylinder air intake valves, and direct fuel injection (DFI) wherein fuel is injected directly into the engine cylinders, typically during or at the end of the compression strokes of the pistons. Diesel fuel injection is also a direct injection type.

DFI fuel delivery systems operate at much higher fuel pressures than do MPFI fuel delivery systems to assure proper injection of fuel into a cylinder having a compressed charge. DFI fuel rails that supply fuel to the fuel injectors may be pressurized to 100 atmospheres or more, for example, whereas MPFI fuel rails must sustain pressures of only about 4 atmospheres.

Fuel delivery for MPFI systems has been achieved in the prior art by an electric fuel pump mounted in the fuel tank. Fuel is delivered, under pressure, to the fuel rail(s) mounted on the engine from the fuel tank via a fuel line running the length of the vehicle. Because of the higher delivery pressures needed in a DFI system, current direct injection designs favor a high pressure mechanical fuel pump mounted close to the fuel rail(s) to minimize the fuel line length and the number of line connections between the pump and the fuel rail(s). The fuel pump typically is driven by a cam follower, also referred to herein as an actuator, such as a roller actuator and, typically, a dedicated cam lobe on the engine camshaft.

In the prior art, a problem exists in the use of cam lobe profiles wherein the actuator is driven at a constant linear velocity and thus zero acceleration. However, resistance of the actuator is not linear. A mismatch of lifting force provided to the lifting force required in some portions of the pump lift profile gives rise to high levels of contact stress between the cam follower and the cam lobe, particularly at high engine speeds, which can be damaging to the cam lobe and/or the cam follower.

What is needed in the art is a method for providing an improved cam lobe profile wherein the maximum contact stress is reduced by increasing the radius of the cam lobe over otherwise high stress portions of the cam follower lift.

It is a principal object of the present invention to reduce high contact stress in a cam lobe and cam follower.

### SUMMARY OF THE INVENTION

Briefly described, a mechanical fuel pump actuator comprises a body portion and a contact portion, such as a roller, mounted to the body portion and configured to ride on a camshaft lobe, typically a dedicated camshaft lobe having three maxima such that the actuator is exercised three times during each revolution of the camshaft. The actuator is slidably disposable in a bore in, as example, an engine block similar to bores provided in the block for conventional hydraulic valve lifters. In prior art camshaft lobes for the present purpose, a portion of the lift profile is such that over a certain angle of camshaft rotation the camshaft lobe imparts a constant velocity, and hence zero acceleration and zero jerk, to the actuator. It has been found that such areas of zero acceleration give rise to undesirably high contact stress between the lobe and the actuator. In the present invention, the radius of curvature of the camshaft lobe lift profile is adjusted such that, between regions of minimum lift and maximum lift, there are no regions imparting zero acceleration to the actuator.

### BRIEF DESCRIPTION OF THE DRAWINGS

The present invention will now be described, by way of example, with reference to the accompanying drawings, in which:

FIG. 1 is an elevational cross-sectional view of a fuel pump actuating system, showing a mechanical fuel pump mounted on an engine, an actuator for actuating the fuel pump, and a tri-lobate camshaft lobe for actuating the actuator;

FIG. 2 is a graph of acutator lift as a function of cam angle degree for the tri-lobate camshaft lobe shown in FIG. 1;

FIG. 3 is a graph of actuator acceleration during the lift cycles shown in FIG. 2, showing both a prior art acceleration curve and an acceleration curve in accordance with the present invention;

FIG. 4 is an enlarged view taken from Circle 4 in FIG. 3;

FIG. 5 is a graph of cam contact stress as a function of cam angle degree, shown for both a prior art cam lobe and a cam lobe improved in accordance with the present invention;

FIG. 6 is an enlarged cross-sectional view of camshaft lobe 30 shown in FIG. 1; and

FIG. 7 is an enlarged view taken from Circle 7 in FIG. 6.

### DESCRIPTION OF THE PREFERRED EMBODIMENTS

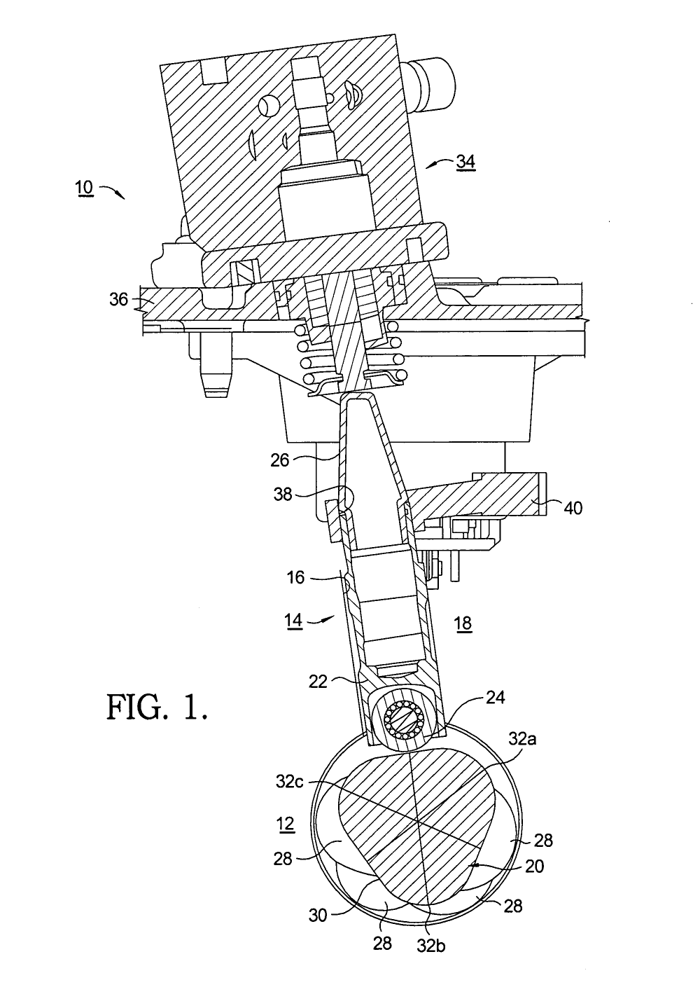

Referring to FIG. 1, in a system 10, in accordance with the present invention, for supplying fuel to a fuel rail (not shown) in an internal combustion engine 12, elongate fuel pump actuator 14 is shown slidably mounted in bore 16 of engine block 18 and riding on camshaft 20. Actuator 14 includes body portion 22 to which roller 24 is rotatably mounted, and contact end 26. Body portion 22 may be formed in any shape desired; however, to minimize the cost of tooling and to assure reliability of function, body portion 22 preferably is generally identical or similar to the body portion of a conventional roller hydraulic valve lifter (RHVL) as is known to be used on an internal combustion engine 12. Also, contact end 26 may include roller 24 or may be a flattened surface for making contact with the camshaft lobe. In the example shown, lubrication of roller 24 and the actuator 14 within engine bore 16 is accomplished in the same way that RHVLs are lubricated. Oil is splashed up from the rotating crank shaft to lubricate the rollers and may also be positively fed through oil galleries (not shown) in the engine block.

Camshaft 20 includes valve lobes 28 for actuating associated intake and exhaust valves (not shown), and a fuel pump lobe 30. Lobe 30 includes equally spaced tri-lobes 32a, 32b, 32c. Pump 34 is mounted above bore 16 and in the valley of the engine, as for example, to lifter oil manifold assembly 36. Roller 24 of body portion 22 of the actuator rides in contact with fuel pump lobe 30 so that, for each revolution of camshaft 20 (or every two revolutions of the engine crank shaft), actuator 14 is caused to fully reciprocate three times. Body portion 22 passes through close-fitting bore 38 of guide 40.

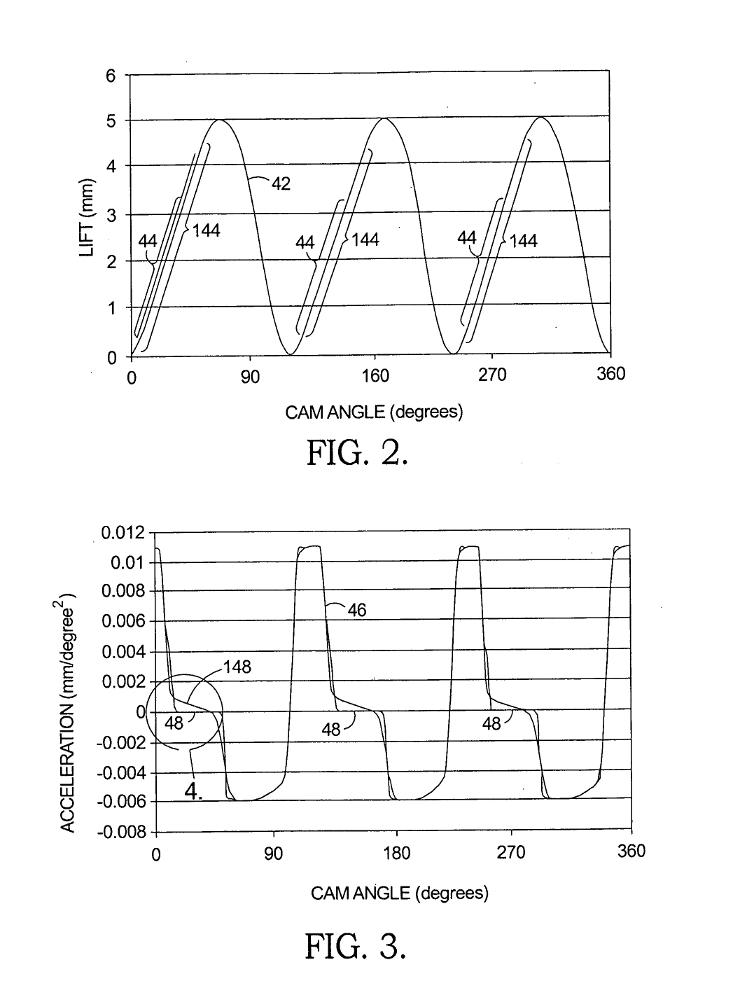

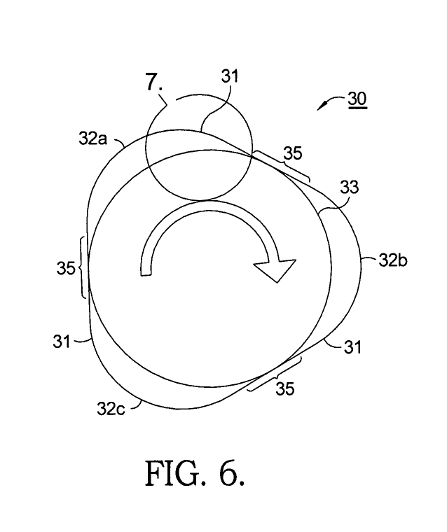

Referring to FIGS. 2 through 5, Curve 42 shows the three reciprocal lifts of actuator 14, each producing, in this example, a lift of 5 mm. In a prior art cam lobe 30, the lifting or ascending limb is virtually linear. Experience with prior art cam lobes 30 has shown that over a certain portion 44 of the lifting limb, an unexpectedly excessive level of contact stress (see curve 46, FIG. 5) is produced, leading to excessive wear of cam lobe 30 and/or roller 24.

Referring to FIG. 6, cam lobe 30 is shown having lifting limbs 31 for each of tri-lobes 32a, 32b, 32c, as shown in FIG. 1. Also, as shown in FIG. 6, a “base circle” 33 is drawn from which the tri-lobes depart. Note that as shown in FIG. 6, cam lobe 30 has short, base-lift regions 35 of negative surface curvature with respect to the cam center between the tri-lobes as a result of the selected radius of base circle 33 but could equally well have no regions of negative surface curvature if a larger base circle radius were selected. However, this would give rise to different slopes for the lifting and lowering limbs of the eccentrics, resulting in different lift profiles.

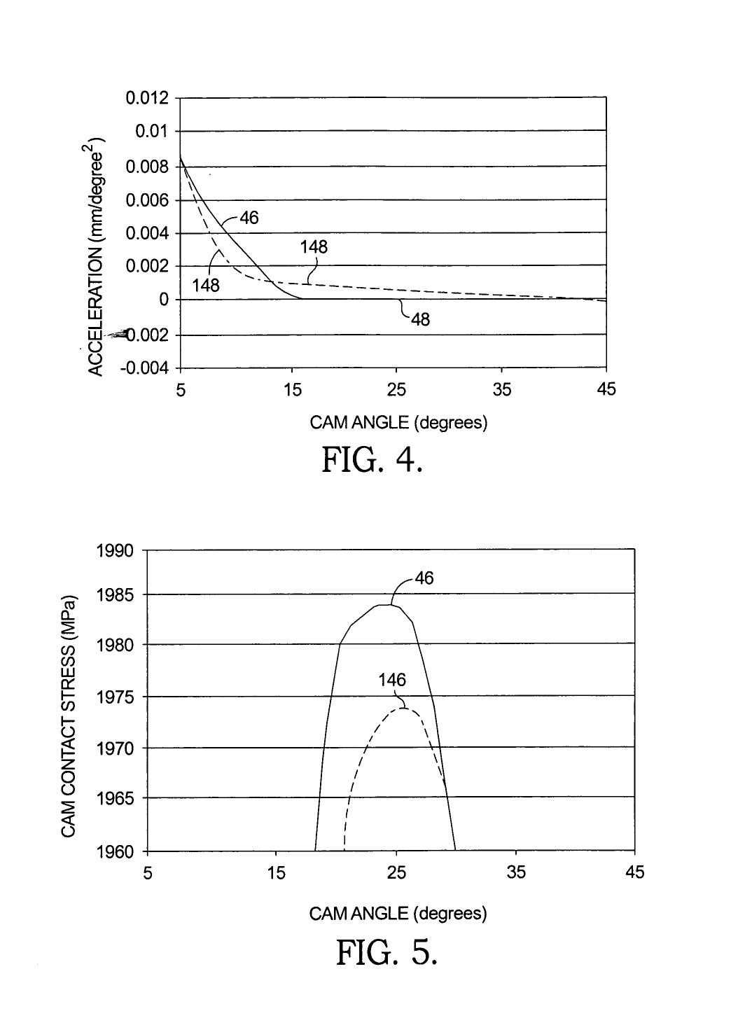

Recall that velocity is the first derivative of lift position (mm/degree); that acceleration is the first derivative of velocity and second derivative of lift position (mm/degree²); and that jerk is the first derivative of acceleration and the second derivative of velocity and the third derivative of lift position (mm/degree³). Curve 46 (FIGS. 3 and 4) shows acceleration of actuator 14 during the three reciprocations. Portions 44 of undesirably high stress are associated with a region 48 of zero acceleration and zero jerk within each lift event.

Referring now to FIGS. 2 through 7, it is an important aspect of the present invention that the maximum level of contact stress of each lifting limb 31 of lobes 32a, 32b, 32c may be reduced to provide a slightly different lifting profile while maintaining the same pumping actuation. It has been found that this is readily accomplished by adjusting the radius of curvature of the locus of points of lifting limbs 31 to provide non-zero acceleration and preferably non-zero jerk that is imparted on the actuator through curvature regions of high stress. Note that instantaneous radius of curvature of points on limbs 31 must not be confused with the geometric radius of those points with respect to the center of cam lobe 30. Rather, the changing radius of curvature is concerned with how fast the geometric radius is changing, and thus directly with acceleration.

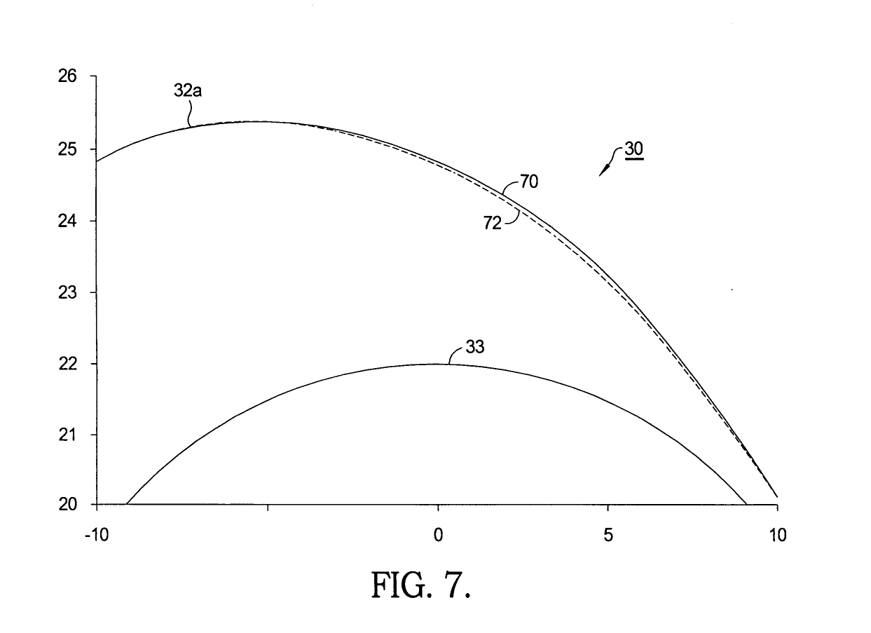

As shown in FIGS. 3 and 4, over the prior art range 48 of zero acceleration and zero jerk, lobe 32a (and by extensions also lobes 32b, 32c) of cam lobe 30 is modified in range 148 to provide non-zero acceleration and preferably non-zero jerk. The change 144 in lift curve 42 (FIG. 2) over range 148 is almost imperceptible. Referring to FIG. 7, in an enlarged view of an area of cam lobe 30 taken from FIG. 6, the actual effective difference in both radius and radius of curvature is shown between the prior art surface profile 70 and a surface profile 72 improved in accordance with the present invention. Note in the present case that as the radius of curvature is increased the geometric radius is decreased. Referring to FIG. 5, it is seen that cam contact stress 146 generated by improved surface profile 72 is substantially reduced over that generated by prior art surface profile 70.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A method for reducing maximum contact stress imparted on a surface of a cam lobe and/or a cam follower of an actuator generated by contact between said cam lobe and said cam follower, comprising the steps of:
a) determining maximum contact stress generated by a reference lifting limb profile of said cam lobe having a reference radius of curvature at points of said contact with said cam follower; and
b) modifying said reference lifting limb profile by changing said reference radius of curvature at said points of contact to cause said maximum contact stress to be reduced in a resulting modified lifting limb profile.

2. A method in accordance with claim 1 wherein said modifying step includes reducing said reference radius of curvature.

3. A camshaft lobe for actuating an actuator for a mechanical fuel pump, the camshaft lobe comprising at least one eccentric portion extending radially from a base-lift region, said eccentric portion having a lifting limb, a maximum-lift region, and a lowering limb, wherein a profile of said lifting region is configured in accordance with claim 2 to reduce maximum contact stress between said actuator and said camshaft lobe.

4. A camshaft lobe in accordance with claim 3 configured such that said actuator is subject to an acceleration rate other than zero at all points between said base-lift region and said maximum-lift region.

5. A camshaft lobe in accordance with claim 3 wherein said camshaft lobe is tri-lobate.

6. An internal combustion engine comprising a camshaft lobe for actuating an actuator for a mechanical fuel pump, said lobe comprising at least one eccentric portion extending radially from a base-lift region, said eccentric portion having a lifting limb, a maximum-lift region, and a lowering limb,
wherein a profile of said lifting region is configured in accordance with claim 2 to reduce maximum contact stress between said actuator and said camshaft lobe.

7. A system for supplying fuel from a source to an internal combustion engine, comprising:
a) a fuel pump connected to said fuel source and to said internal combustion engine;
b) an actuator for actuating said fuel pump; and
c) a camshaft lobe mounted on a camshaft of said engine for causing reciprocation of said actuator to drive said fuel pump,
wherein said camshaft lobe includes at least one eccentric portion extending radially from a base-lift region, said eccentric portion having a lifting limb, a maximum-lift region, and a lowering limb, and
wherein a profile of said lifting region is configured in accordance with claim 2 to reduce maximum contact stress between said actuator and said camshaft lobe.

8. A camshaft lobe for actuating an actuator, the camshaft lobe comprising at least one eccentric portion extending radially from a base-lift region, said eccentric portion including a lifting limb, a maximum-lift region, and a lowering limb,
wherein a profile of said lifting limb is configured by determining maximum contact stress generated by a reference lifting limb profile of said camshaft lobe including a reference radius of curvature at points of said contact with said actuator, and modifying said reference lifting limb profile by changing said reference radius of curvature at said points of contact to reduce said maximum contact stress between said actuator and a resulting modified lifting limb profile of said camshaft lobe.

9. A method for forming a camshaft lobe that operates to actuate an actuator, said method comprising the step of forming at least one eccentric portion including a lifting limb, a maximum-lift region, and a lowering limb, wherein said lifting limb includes a radius of curvature that imparts an acceleration on said actuator that is greater than zero.

10. A method in accordance with claim 9 wherein said lifting limb includes a radius of curvature that imparts a jerk on said actuator that is greater than zero.

11. A camshaft lobe for actuating an actuator, the camshaft lobe comprising at least one eccentric portion including a lifting limb, a maximum-lift region, and a lowering limb, wherein a profile of said lifting limb includes means for imparting an acceleration on said actuator that is greater than zero.

12. A camshaft lobe in accordance with claim 11 wherein said lifting limb includes means for imparting a jerk on said actuator that is greater than zero.

13. A method in accordance with claim 1 wherein said actuator is subject to an acceleration rate other than zero.

14. A method in accordance with claim 1 wherein said actuator is subject to an acceleration rate other than zero at all points on said modified lifting limb profile.
